(19) United States
(12) Patent Application Publication
(10) Pub. No.: US 2014/0309751 A1
(43) Pub. Date: Oct. 16, 2014

(54) CONTROLLER, DEVICE CONTROL SYSTEM, COMPUTER PROGRAM, COMPUTER READABLE STORAGE MEDIUM

(71) Applicant: KABUSHIKI KAISHA YASKAWA DENKI, Kitakyushu-shi (JP)

(72) Inventor: Takeshi NAGATA, Kitakyushu-shi (JP)

(73) Assignee: KABUSHIKI KAISHA YASKAWA DENKI, Kitakyushu-shi (JP)

(21) Appl. No.: 14/251,649

(22) Filed: Apr. 14, 2014

(30) Foreign Application Priority Data
Apr. 15, 2013 (JP) 2013-085320

(51) Int. Cl. G05B 15/02

(52) U.S. Cl. CPC G05B 15/02
USPC 700/12

(57) ABSTRACT

A controller includes a user interface, a selection section, and a state display section. The user interface includes an image display device and is coupled to an external device including a motor drive shaft as a control target. The selection section is configured to display at least one option image and configured to transmit a control command to the external device based on a selection result corresponding to the option image. The state display section is configured to display at least one state image corresponding to the at least one option image, and configured to reflect a state of the external device into the state image.

### CROSS-REFERENCE TO RELATED APPLICATIONS

The present application claims priority under 35 U.S.C. §119 to Japanese Patent Application No. 2013-085320, filed Apr. 15, 2013. The contents of this application are incorporated herein by reference in their entirety.

### BACKGROUND

### Technical Field

The present invention relates to a controller, a device control system, a computer program, and a computer readable storage medium.

Japanese Unexamined Patent Application Publication No. 7-44477 discloses a control system including a plurality of multimedia devices and a control device connected to the plurality of multimedia devices through a network so as to control the plurality of multimedia devices. The control device includes a display with a control panel display window. The control panel display window displays control mode selection sections in the form of radio buttons among which to select a control mode.

Japanese Patent No. 4346081 discloses a control system including a control unit and a programmable display. The programmable display includes a display section that provides equal to or equal to or more than three patterns of display including an operation display pattern and a state display pattern. The operation display pattern is switched by manual operation by a user. The state display pattern is switched according to change in the state of the control unit.

According to one aspect of the present disclosure, a controller includes a user interface, a selection section, and a state display section. The user interface includes an image display device and is coupled to an external device including a motor drive shaft as a control target. The selection section is configured to display at least one option image and configured to transmit a control command to the external device based on a selection result corresponding to the option image. The state display section is configured to display at least one state image corresponding to the at least one option image, and configured to reflect a state of the external device into the state image.

According to another aspect of the present disclosure, a controller includes a user interface, a selection section, and a state display section. The user interface includes an image display device and is coupled to an external device as a control target. The selection section is configured to display at least one option image and configured to transmit a control command to the external device based on a selection result corresponding to the option image. The state display section is configured to display at least one state image corresponding to the at least one option image, and configured to reflect a state of the external device into the state image.

According to another aspect of the present disclosure, a device control system includes the above-described controller and an external device coupled to the controller.

According to another aspect of the present disclosure, a computer program causes a computer to function as a controller. The controller includes a user interface, a selection section, and a state display section. The user interface includes an image display device and is coupled to an external device including a motor drive shaft as a control target. The selection section is configured to display at least one option image and configured to transmit a control command to the external device based on a selection result corresponding to the option image. The state display section is configured to display at least one state image corresponding to the at least one option image, and configured to reflect a state of the external device into the state image.

According to the other aspect of the present disclosure, a computer readable information storage medium stores the above-described computer program.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a schematic view of an exemplary device control system according to an embodiment;

FIG. 2 is a block diagram illustrating a physical configuration of an operation terminal;

FIG. 3 is a functional block diagram of the device control system;

FIG. 4 is an exemplary window that an image display device displays on the operation terminal;

FIG. 5 is an enlarged view of an override specifying section; and

FIG. 6 is an enlarged view of a servo ON/OFF specifying section.

### DESCRIPTION OF THE EMBODIMENTS

The embodiments will now be described with reference to the accompanying drawings, wherein like reference numerals designate corresponding or identical elements throughout the various drawings.

GUIs (Graphical User Interfaces) use radio buttons or checkboxes to show a plurality of options for a user to select one or more options. The inventors have found that radio buttons and checkboxes are used mostly for an input from a user and less likely for execution of an operation. Even when radio buttons and or checkboxes are used to execute some operation such as state selection, the selected state merely shows an internal state of an information processing device itself using the GUI. Thus, no or minimal consideration has been given to discrepancies between the state selected on the radio button or checkbox and the actual state.

State discrepancies are likely to occur when the device to operate is an external device. No or few GUIs are known to intuitively and clearly show a relationship between the actual state of the external device and the details of the operation to be executed with respect to the external device.

In view of this, the inventors studied and developed a device control system that controls a device including a motor drive shaft in an attempt to improve the safety of driving the motor drive shaft. As a result, the inventors conceived of a novel and unique device control system and controller. An embodiment of the unique device control system and controller will be described in detail below.

### Device Control System According to the Embodiment

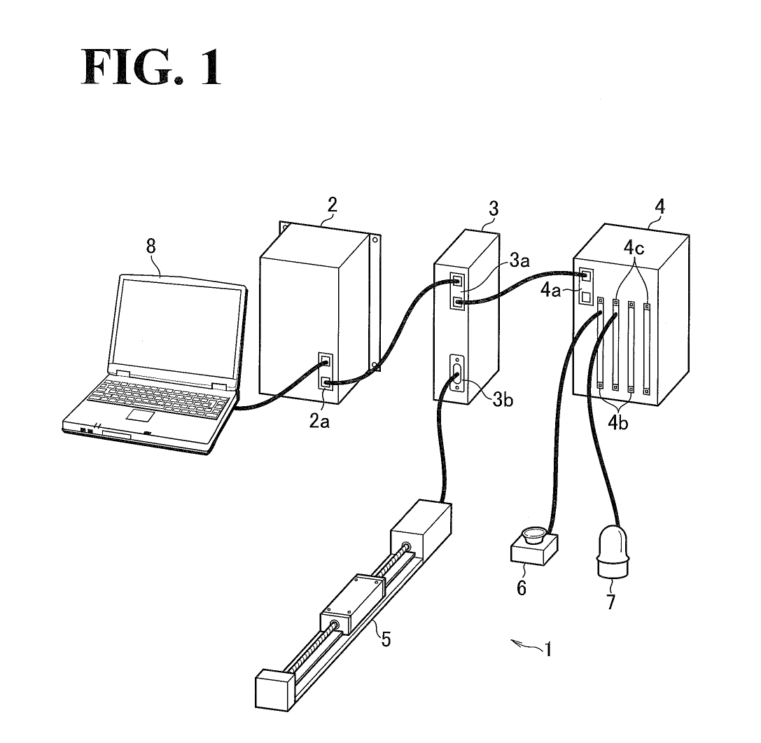

FIG. 1 is a schematic view of an exemplary device control system 1 according to an embodiment. As shown in FIG. 1, the device control system 1 includes a PLC 2, a servo controller 3, an I/O unit 4, a linear slider 5, a switch 6, a lamp 7, and a control terminal 8.

The PLC 2 is a device which controls a FA (Factory Automation) device such as a servo shaft. While in this embodiment the PLC 2 is what is called as a programmable logic controller, any other device is possible insofar as the device is capable of controlling at least one another device based on a control program. As used herein, the term “control program” means information that describes an operation of a device coupled to the PLC 2 in terms of a logical relationship or a time axis. Examples of the control program include, but are not limited to, what is called a ladder program and a time chart. Exemplary control targets of the PLC 2 include, but are not limited to, input-output devices such as: servo shafts, such as the linear slider 5, that are driven through the servo controller 3; the switch 6; and the lamp 7 A program executed by the PLC 2 is input into and stored in the PLC 2 as electronic data. The PLC 2 includes an information communication connector 2a.

The servo controller 3 is a combination of a servo amplifier to control a servo motor and a control circuit of the servo amplifier. The servo controller 3 is provided with an information communication connector 3a and a servo connector 3b. The information communication connector 3a provides connection with other devices such as the PLC 2. The servo connector 3b provides connection with servo mechanisms such as the linear slider 5. In this embodiment, the servo connector 3b is connected with the linear slider 5, which is an exemplary motor drive shaft.

The linear slider 5 is a combination mechanism of a servo motor, an encoder, ball screws, and a slide table. The ball screws are coupled to the output shafts of the servo motor. The slide table is guided by a linear guide and driven by the ball screws. The slide table is driven in accordance with the output of the servo controller 3. As used herein, the term “motor drive shaft” refers to a mechanism driven by a drive source that is an electric motor, such as the servo motor, capable of controlling the amount of driving. The term motor drive shaft is thus called when the electric motor is in focus. The electric motor may be other than the servo motor; other examples include, but are not limited to, a step motor. Also the electric motor may not necessarily provide rotative power; it is also possible to use a linear motor. Among the motor drive shafts, a shaft using a servo mechanism will be referred to as a servo shaft. Therefore, the linear slider 5 according to this embodiment is a servo shaft.

The I/O unit 4 includes an information communication connector 4a and a plurality of input-output contact points. The information communication connector 4a provides connection with other devices such as the PLC 2. The plurality of input-output contact points are where input-output devices are connected. The input-output contact points of the I/O unit 4 include input connectors 4b and output connectors 4c. The input connectors 4b include a plurality of contact points for input use (which will be referred to as input contact points), and the output connectors 4c include a plurality of contact points for output use (which will be referred to as output contact points). The I/O unit 4 transmits input states of the input contact points of the input connectors 4b to the PLC 2 through the information communication connector 4a. The I/O unit 4 also controls states of the output contact points of the output connectors 4c in accordance with a command transmitted from the PLC 2 through the information communication connector 4a. A function of the I/O unit 4 is to add external input-output contact points to the PLC 2. In this embodiment, exemplary input-output devices connected to the I/O unit 4 are the switch 6 and the lamp 7. The switch 6 is a mechanical switch of the normally open (that is, contact the point A) type and connected to the input connector 4b. The lamp 7 is connected to the output connector 4c. As used herein, the term “input-output contact point” refers to a contact point at which information is input or output depending on highness or lowness of impedance. The term input-output device refers to a device coupled to the PLC 2 at an input-output contact point.

In this embodiment, as shown in FIG. 1, the information communication connectors 2a, 3a, and 4a are connected to each other by means of cascade connection through cables. Thus, the PLC 2, the servo controller 3, and the I/O unit 4 are communicable with each other.

The operation terminal 8 is a controller (control device) coupled to an external device as a control target through a telecommunication line. The operation terminal 8 includes a user interface with an image display device, that is, a monitor. The PLC 2, the servo controller 3, the linear slider 5, the switch 6, and the lamp 7 are directly or indirectly coupled to the operation terminal 8, and thus these devices correspond to the external device as the control target of the operation terminal 8. As used herein, the term “controller” refers to a device that controls the external device through a telecommunication line. In FIG. 1, the operation terminal 8 is exemplified as the controller to control the PLC 2 and other devices as external devices. While in the following description the operation terminal 8 is treated as the controller and the PLC 2 is treated as one external device, the controller may be in any other form within the above-described scope of definition of the controller. For example, in FIG. 1, it is possible to treat the servo controller 3, the linear slider 5, the switch 6, and the lamp 7 as external devices, and to treat the operation terminal 8 and the PLC 2 collectively as the controller. It is also possible to combine the operation terminal 8 and the PLC 2 into a single device.

The operation terminal 8 according to this embodiment also serves as a control program generation device that generates a control program to be executed by the PLC 2. The generated control program is transferred to and stored in the PLC 2. Thus, the operation terminal 8 and the PLC 2 may not necessarily be coupled to each other only in order for the PLC 2 to execute the control program. Still, it is necessary to control the PLC 2 and other devices on commands from the operation terminal 8, such as settings on the PLC 2 and other devices and checking the behavior of the generated control program. In this case, the operation terminal 8 serves as the control device and controls the PLC 2 and other devices as external devices.

While the operation terminal 8 may be a dedicated apparatus, the example shown is a general-purpose computer. This computer is implemented as the operation terminal 8 by executing a computer program. The computer program may be stored in any of various light discs or a semiconductor memory such as a computer readable information storage medium, and the computer preferably installs the computer program from the medium. The computer may also download the computer program from any of various information communication networks such as the Internet. The computer program may also be implemented using what is called cloud computing; specifically, the function of the computer program may be provided from a server at a remote place through an information communication network. In this embodiment, the function of the operation terminal 8 is implemented as a part of the control program generation device.

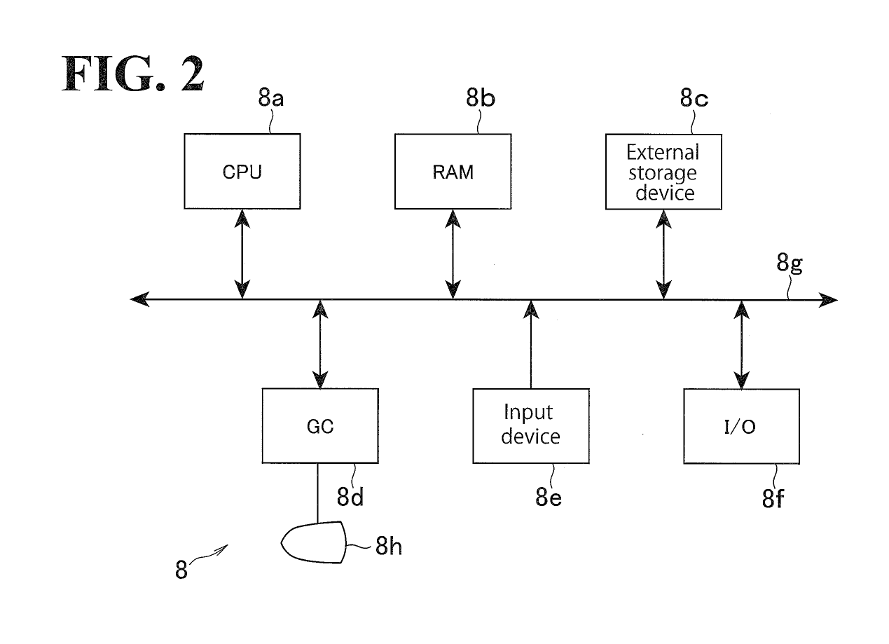

FIG. 2 is a block diagram illustrating a physical configuration of the operation terminal 8. The operation terminal 8 is a general-purpose computer, and includes a CPU (Central Processing Unit) 8a, a RAM (Random Access Memory) 8b, an external storage device 8c, a GC (Graphics Controller) 8d, an input device 8e, and an I/O (Input/Output) 8f. The CPU 8a, the RAM 8b, the external storage device 8c, the GC 8d, the input device 8e, and the I/O 8f are connected to each other through a data bus 8g and thus capable of exchanging electrical signals through the data bus 8g. The external storage device 8c is a device that statically records information. Examples include, but are not limited to, an HDD (Hard Disk Drive) and an SSD (Solid State Drive). The GC 8d outputs a signal to a monitor 8h. The monitor 8h displays the signal in the form of an image. The monitor 8h is for the user to visually recognize the image. Examples of the monitor 8h include, but are not limited to, a CRT (Cathode Ray Tube) and what is called a flat panel display. The input device 8e is a device for the user to input information. Examples of the input device 8e include, but are not limited to, a keyboard, a mouse, and a touch panel. The I/O 8f is an interface on which the operation terminal 8 exchanges information with an external device, which is the PLC 2 in this embodiment.

For simplified description and illustration, those configuration details and wiring details irrelevant to understanding of this embodiment are omitted from the above description and FIGS. 1 and 2. For example, a power source line and a ground line are not shown. There is no particular limitation to the form of the connections, the type of the connectors, and the kind and number of the control target devices; any other variations are possible.

### Configuration of the Device Control System According to the Embodiment

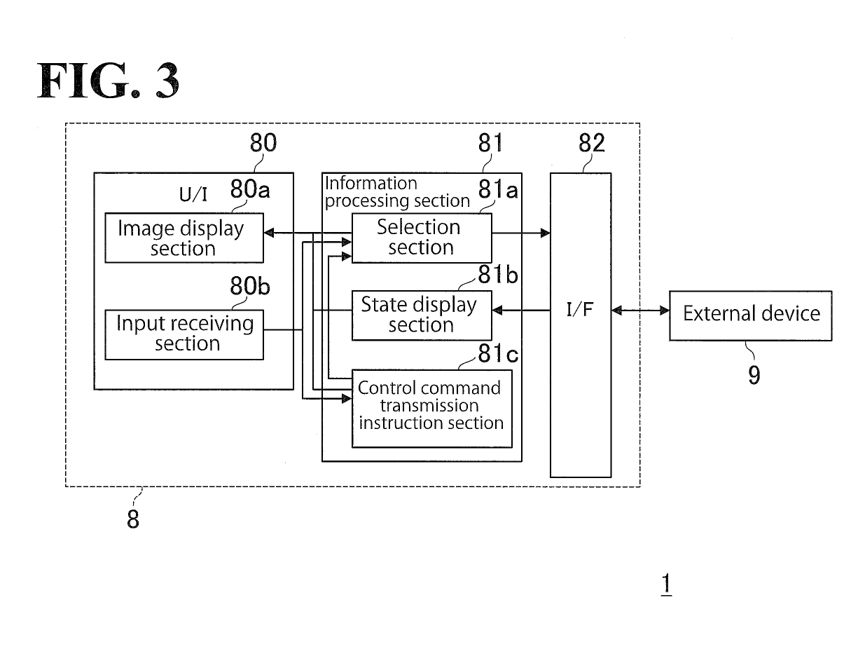

FIG. 3 is a functional block diagram illustrating the device control system 1 according to this embodiment. The operation terminal 8 includes a user interface 80, an information processing section 81, and an interface 82.

The user interface 80 shows information to the user and receives information input from the user. The user interface 80 includes an image display device 80a and an input receiving device 80b. The image display device 80a shows information to the user by displaying the information in the form of an image. The input receiving device 80b receives information input from the user. In this embodiment, the image display device 80a corresponds to the GC 8d and the monitor 8h shown in FIG. 2. The input receiving device 80b corresponds to the input device 8e shown in FIG. 2. In particular, in this embodiment, the input device 8e includes what is called a pointing device such as a mouse and a touch panel. With the pointing device, the user is able to make an input by specifying coordinates on the image on the image display device 80a.

The information processing section 81 performs various kinds of information processing in the operation terminal 8. Specifically, the information processing section 81 corresponds to the CPU 8a and the work area RAM 8b shown in FIG. 2. As shown in FIG. 3, the information processing unit 81 includes a selection section 81a, a state display section 81b, and a control command transmission instruction section 81c. These elements are schematically shown in FIG. 3 in the form of blocks corresponding to functions contained in information processing implemented by a program that the information processing section 81 executes. Operations associated with these blocks will be described later.

The interface 82 provides electrical communication between the operation terminal 8 and an external device 9, and corresponds to the I/O 8f shown in FIG. 2.

For simplified description and illustration, the above-described functional blocks of the device control system 1 are only those functions relevant to understanding of this embodiment, and those functions less relevant are omitted from description. Specifically, although the operation terminal 8 also serves as a control program generation device as described above, a configuration of generating the control program is less relevant to the subject matter of this embodiment and thus is not elaborated in FIG. 3. Thus, the device control system 1 may have various other functions in addition to those functions shown in FIG. 3. Where necessary, the following description will refer to FIG. 3.

### Operation Window of the Operation Terminal According to the Embodiment

Next, description will be made by way of examples with regard to an operation window that the operation terminal 8 displays on the image display section 80a and to an operation executed on the operation window.

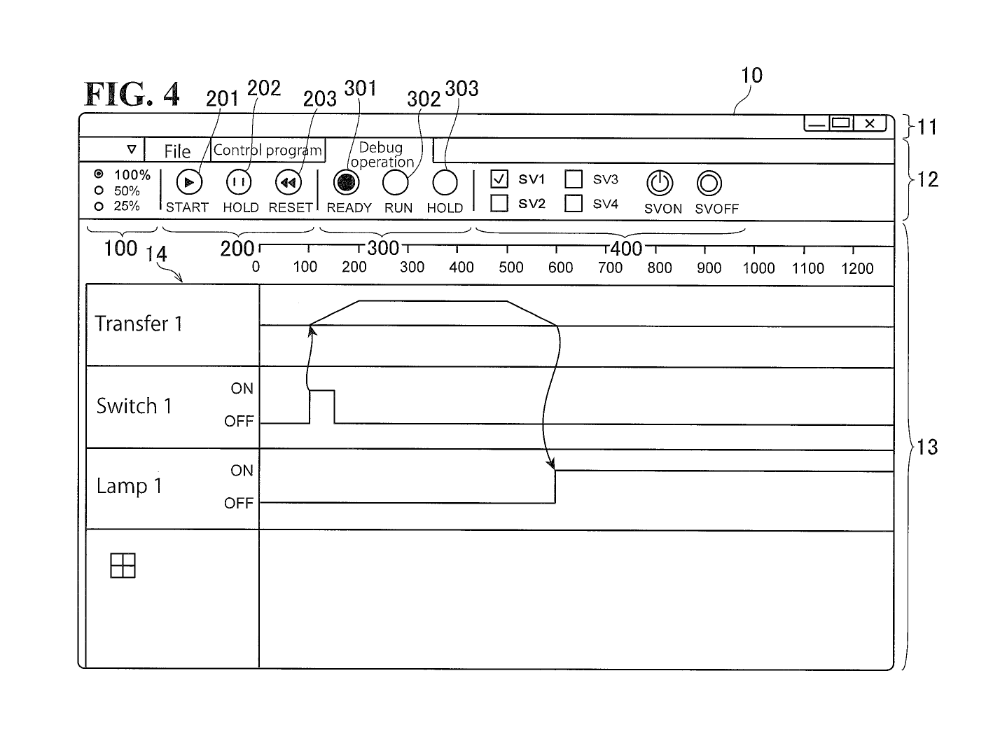

FIG. 4 is an exemplary window that the operation terminal 8 displays on the image display device. The operation terminal 8 is a general-purpose computer using an OS (Operating System) capable of what is called a multi-task and multi-window view. As shown in FIG. 4, an application to cause the computer to function as the operation terminal 8 is displayed on a window 10. The window 10 described here is an exemplary window that the operation terminal 8 displays, and any changes in design and layout of the window 10 are possible.

A title area 11 is on the top edge of the window 10. Under the title area 11, an area hereinafter referred to as ribbon 12 is disposed. The ribbon 12 contains icons of device states and icons of various commands available to be designated with respect to the operation terminal 8. On top of the ribbon 12, a plurality of kinds of tabs are disposed. The ribbon 12 is switchable among the plurality of kinds of tabs, and in each of the tabs, the ribbon 12 provides different kinds of icons. Since FIG. 4 is concerning an operation of controlling the external devices using the operation terminal 8 through the PLC 2, the “Debug operation” tab, which indicates control of an external device, is selected in the ribbon 12. Immediately under the ribbon 12, a work area 13 is disposed. The work area 13 is an area where the user receives visual presentations of various kinds of information and makes various specifications. The display details on the work area 13 may be open to change in conjunction with the ribbon 12 being switched. In this embodiment, a time chart 14 is shown as a control program to be executed by the PLC 2.

The time chart 14 includes an alignment of different charts with time (unit: millisecond, hereinafter referred to as ms) on the horizontal axis and a state of each control target device on the vertical axis. As shown in FIG. 4, the chart named “Transfer 1” corresponds to the linear slider 5, which is a servo shaft. The chart named “Switch 1” corresponds to the switch 6. The chart named “Lamp 1” corresponds to the lamp 7. The chart named “Transfer 1” shows the movement speed of the servo shaft. The chart named “Switch 1” and the chart named “Lamp 1” show signal levels at the respective I/O contact points; a high level of signal is indicated as ON, while a low level of signal is indicated as OFF.

The time chart 14 itself is less relevant to the subject matter of this embodiment and thus will not be elaborated further than the following. The time chart 14 shows such an operation that upon pressing of the switch 6, the linear slider 5 accelerates for 100 ms, makes a uniform movement for 300 ms, decelerates for 100 ms, and stops. Upon stopping of the linear slider 5, the lamp 7 turns on.

The ribbon 12 contains icons indicating instructions available for the user to make while the “Debug operation” tab is selected or icons indicating information to be notified to the user. These icons are divided into four groups of, from the left in FIG. 4, an override specifying section 100, a time chart execution specifying section 200, a controller state display section 300, and a servo ON/OFF specifying section 400.

The override specifying section 100 is where to specify the progression rate of time during execution of the time chart 14. A coefficient used to specify the progression rate of time will be referred to as override coefficient. As shown in FIG. 4, when an override coefficient of 100% is specified, the progression rate of time on the time chart 14 is 100% with respect to actual time. That is, the time on the time chart 14 goes on as actual time goes on. In this case, the time chart 14 operates with an intended progression rate. When an override coefficient of 50% is specified, the progression rate of time during execution of the time chart 14 is 50% with respect to actual time. This results in twice as much time to complete the same operation. For example, when the override coefficient is 100%, on the time chart 14 of FIG. 4, the lamp 7 turns on 500 ms after the switch 6 was pressed. When the override coefficient is 50%, the same operation takes twice as much time, 1000 ms. When the override coefficient is 25%, the same operation takes four times as much time, 2000 ms. The override coefficient itself is a parameter set in the PLC 2.

The time chart execution specifying section 200 is where to instruct execution and termination of the time chart 14. An execution button 201 is an icon imitating a start button. When the execution button 201 is selected, the time chart 14 starts. A pause button 202 is an icon imitating a hold button. When the pause button 202 is selected, the time chart 14 currently in execution comes to a pause, and the execution start time point of the time chart 14 is set at the stopping time point of the time chart 14. A stop button 203 is an icon imitating a reset button. When the stop button 203 is selected, the time chart 14 currently in execution is stopped, and the execution start time point of the time chart 14 is set at the initial time point.

The controller state display section 300 shows current states of the PLC 2. A waiting state indicator 301 is an icon imitating a lamp. The waiting state indicator 301 flashes to indicate that the PLC 2 is ready to start execution of the time chart 14. A running state indicator 302 is an icon imitating a lamp. The running state indicator 302 flashes to indicate that the PLC 2 is in a state of executing the time chart 14. A stop state display lamp 303 is an icon imitating a lamp. The stop state display lamp 303 flashes to indicate that the PLC 2 is in a state of stopping execution of the time chart 14 in the middle of execution.

The servo ON/OFF specifying section 400 is where to specify switching between servo ON and servo OFF for each individual servo shaft coupled to the PLC 2 or specify switching between servo ON and servo OFF collectively for a plurality of servo shafts coupled to the PLC 2. As used herein, the term “servo ON” refers to a state in which a servo motor is subjected to positional feedback control to electrically and magnetically constrain rotation of the servo shaft of the servo motor. The term “servo OFF” refers to a state in which a servo motor is not subjected to positional feedback control, so that the servo shaft of the servo motor is allowed for free rotation.

The override specifying section 100, the time chart execution specifying section 200, the controller state display section 300, and the servo ON/OFF specifying section 400 are all GUIs. Among these GUIs, the override specifying section 100 and the servo ON/OFF specifying section 400 are particular GUIs more relevant to the subject matter of this embodiment. These two GUIs will be described below.

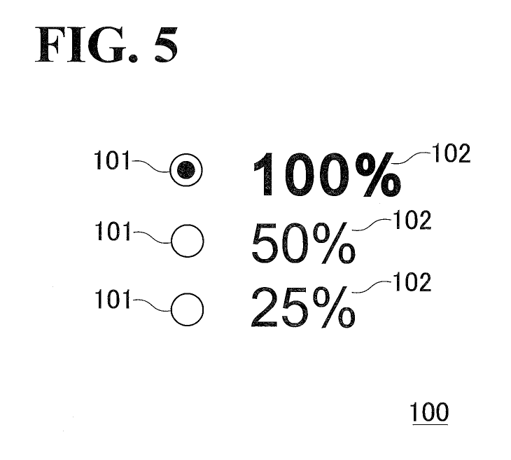

FIG. 5 is an enlarged view of the override specifying section 100. The override specifying section 100 includes option images 101 and state images 102. The option images 101 are radio buttons to be selected by the user. The state images 102 indicate override coefficients corresponding to the respective option images 101.

Since the option images 101 are radio buttons, when the user selects any one of the option images 101, only the selected option image 101 is checked. In the example shown in FIG. 5, the top option image 101 is checked. Then, when one of the option images 101 is selected, the override coefficient corresponding to the selected option image 101 is transmitted from the operation terminal 8 to the PLC 2. As a result, the override coefficient currently stored in the PLC 2 is updated.

This operation is executed by the selection section 81a of the operation terminal 8 The selection section 81a displays the option images 101, and based on a result of selection among the option images 101, transmits the corresponding override coefficient as a control command to the PLC 2, which is an external device.

The state images 102 are different from common radio buttons in that each state image 102 indicates not only information of the corresponding option image 101 but also indicates a state of the external device. In this example, the override coefficient stored in the PLC 2 is indicated by highlighting the state image 102 corresponding to the override coefficient currently set in the PLC 2. In the example shown in FIG. 5, the top state image 102 is displayed in bold. It will be readily appreciated that the state images 102 may be highlighted in any other manner. Other than the use of bold letters, it is possible to, for example, change the color of the letters, highlight the letters, use an animated indication such as blinking, and enlarge the letters.

This operation is executed by the state display section 81b of the operation terminal 8. The state display section 81b displays the state images 102, and detects the state of the external device 9 at a predetermined period (for example, 1-second period) to reflect the detected state of the external device 9 in the state images 102. In this example, the state display section 81b reads the override coefficient every one second from the PLC 2 to highlight a corresponding state image 102.

In this configuration, the PLC 2, which is an external device, may notify the state of the external device in response to an access from the state display section 81b of the operation terminal 8. Thus, the PLC 2 does not make information communication with the operation terminal 8 voluntarily. This eliminates or minimizes any load involved with additional processing such as adding a specific configuration to the external device such as the PLC 2, and counting the communication timing. When the state of the external device is stored in a storage device directly accessible by a method such as DMA (Direct Memory Access) through a telecommunication line, then the state display section 81b directly accesses the storage device to detect the state of the external device. This saves the external device any load involved with the access in detecting the state of the external device. This, in turn, ensures no or minimal influence on the operation of the external device.

This will be further described below. When the control device controls the external device, various factors may cause discrepancies between the state of the external device designated on the control device and the actual state of the external device. In this embodiment, after the override coefficient has been specified on the operation terminal 8, elapse of some period of time is inevitable before the specified override coefficient is actually rewritten on the PLC 2. During this period of time, there is a discrepancy between the override coefficient specified on the operation terminal 8 and the state on the PLC 2. Additionally, when a teaching pendant or another operation device other than the operation terminal 8 is used to operate the PLC 2, a discrepancy can occur between the state specified on the operation terminal 8 and the state on the PLC 2. Such discrepancies are more likely to occur in device control systems involving physical operations. The device control system 1 including the motor drive shaft as described in this embodiment is a typical example.

In this situation, it is difficult or impossible to indicate the state of the external device with a conventional radio button, and the user is unable to recognize the occurrence of the discrepancy. It may be possible to display the state of the external device using an additional configuration. However, if the GUI for operation of the external device is separate from the GUI to indicate the state of the external device, it is difficult to instinctively and instantaneously grasp the occurrence of the discrepancy.

Contrarily, in this embodiment, the state images 102 respectively corresponding to the option images 101 are displayed, and the state of the external device 9 is reflected in the state images 102. This ensures immediate grasp of a relationship between the state of the external device 9 that the user intends to designate and the current state of the external device 9.

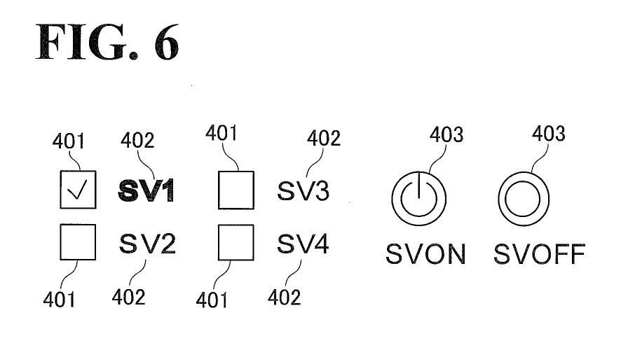

FIG. 6 is an enlarged view of a servo ON/OFF specifying section 400. The servo ON/OFF specifying section 400 includes option images 401, state images 402, and control command transmission instruction images 403. The option images 401 are checkboxes for the user to select a state image. The state images 402 correspond to the respective option images 401. The control command transmission instruction images 403 are command buttons for servo ON and servo OFF.

The notations “SV1” to “SV4” of the state images 402 indicate identification names of the servo shafts coupled to or available to be coupled to the PLC 2. While in FIG. 1 a single servo shaft is coupled to the PLC 2, the PLC 2 is capable of accepting a maximum of four servo shafts. Thus, the state images 402 are denoted with four identification names of servo shafts. This, however, should not be construed as limiting the upper limit for the number of the servo shafts. It is also possible to display only a servo shaft coupled to the PLC 2.

The option images 401 are checkboxes, which enables the user to select any of the option images 401. For example, the user may select all the option images 401 or select none of the option images 401. A selected option image(s) 401 is(are) checked. In the example shown in FIG. 6, the upper left option image 401 is checked.

After the selection among the option images 401, the user makes an instruction to the control command transmission instruction images 403. Since the control command transmission instruction images 403 are buttons, an instruction is made on one of the buttons to make a command for servo ON or servo OFF with respect to the servo shaft(s) corresponding to the selected option image(s) 401. In the example shown in FIG. 6, the control command transmission instruction image 403 on the left means an instruction for servo ON, while the control command transmission instruction image 403 on the right means an instruction for servo OFF.

This operation is executed by the selection section 81a and the control command transmission instruction section 81c of the operation terminal 8. Specifically, the selection section 81a displays the option images 401, and based on a result of selection among the option images 401, transmits at least either one of a servo ON command and a servo OFF command as a control command to the PLC 2, which is an external device. The transmission of the control command is done at a command from the control command transmission instruction section 81c. Then, the control command transmission instruction section 81c displays the control command transmission instruction images 403, and based on an instruction to either one of the control command transmission instruction images 403, causes the selection section 81a to transmit a control command

The state images 402 are different from common checkboxes in that each state image 402 indicates not only information of the corresponding option image 401 but also indicates a state of the external device. Specifically, in this embodiment, whether the servo shaft coupled to the PLC 2 is in servo ON state or servo OFF state is indicated by highlighting the state image 402 corresponding to the servo shaft in servo ON state. In the example shown in FIG. 6, the upper left state image 402 is displayed in bold to indicate that the servo shaft denoted with the identification name “SV1” is in servo ON state. This operation is executed by the state display section 81b of the operation terminal 8, similarly to the case with the state images 102 shown in FIG. 5. In the example shown in FIG. 6, every one second, the state display section 81b reads from the PLC 2 whether each servo shaft is in servo ON state or servo OFF state, and highlights the state image 402 corresponding to the servo shaft in servo ON state.

This will be further described below. Similarly to the case with FIG. 5, a discrepancy can occur between the state of the external device designated on the control device and the state of the actual external device, and the operation terminal 8 according to this embodiment ensures immediate grasp of a relationship between the state of the to-be-designated external device 9 and the current state of the external device 9. As shown in FIG. 6, in the case of a combination of states of the to-be-designated external device 9, it is possible to select a desired combination in advance and then transmit a collective control command. This ensures a quick command sent to the external device.

The radio buttons and the checkboxes shown in FIGS. 5 and 6 are provided for exemplary purposes only, and should not be construed as limiting the option images. There is no particular limitation to the type of the state images; any type of image is possible insofar as the image reflects the state of the external device 9 and corresponds to the option image.

In this respect, assume that at least one state is to be selected among equal to or more than three states with option images, and that the state images each indicate at least one state among equal to or more than three states. In this case, the relationship between the specifying state on the controller and the state of the external device is instinctively and readily grasped. This is because of the following reason. When one state is to be selected from among two states of ON and OFF, this results in four combinations of the state to be specified on the controller and the state of the external device. When one state is to be selected from among equal to or more than three states, this results in an exponential increase in the number of combinations of the state to be specified on the controller and the state of the external device. In this case, unless the option images are separated from the state images, it is much more difficult to immediately grasp the states than in the case of evoking the simple concept of ON/OFF. This, however, should not be construed as excluding the case of two states as the states indicated by the option images and the case of two states as the states indicated by the state images.

Obviously, numerous modifications and variations of the present disclosure are possible in light of the above teachings It is therefore to be understood that within the scope of the appended claims, the present disclosure may be practiced otherwise than as specifically described herein.

What is claimed as new and desired to be secured by Letters Patent of the United States is:

1. A controller comprising:
a user interface comprising an image display device and coupled to an external device comprising a motor drive shaft as a control target;
a selection section configured to display at least one option image and configured to transmit a control command to the external device based on a selection result corresponding to the option image; and
a state display section configured to display at least one state image corresponding to the at least one option image and configured to reflect a state of the external device into the state image.

2. The controller according to claim 1,
wherein at least one state is selectable from among equal to or more than three states on the at least one option image, and
wherein the at least one state image is an image of the at least one state selected from among the equal to or more than three states.

3. The controller according to claim 1, wherein the state display section is configured to highlight the at least one state image so as to reflect the state of the external device into the state image.

4. The controller according to claim 1, wherein the state display section is configured to detect the state of the external device at a predetermined period.

5. The controller according to claim 1, wherein the state display section is configured to access a directly accessible storage device through a telecommunication line so as to detect the state of the external device.

6. The controller according to claim 1, further comprising a control command transmission instruction section configured to display a control command transmission instruction image and configured to transmit a control command to the selection section based on an instruction to the control command transmission instruction image.

7. A controller comprising:
a user interface comprising an image display device and coupled to an external device as a control target;
a selection section configured to display at least one option image and configured to transmit a control command to the external device based on a selection result corresponding to the option image; and
a state display section configured to display at least one state image corresponding to the at least one option image and configured to reflect a state of the external device into the state image.

8. A device control system comprising:
the controller according to claim 1; and
an external device coupled to the controller.

9. A computer program causing a computer to function as a controller, the controller comprising:
a user interface comprising an image display device and coupled to an external device comprising a motor drive shaft as a control target;
a selection section configured to display at least one option image and configured to transmit a control command to the external device based on a selection result corresponding to the option image; and
a state display section configured to display at least one state image corresponding to the at least one option image and configured to reflect a state of the external device into the state image

10. A computer readable information storage medium storing the computer program according to claim 9.

11. The controller according to claim 2, wherein the state display section is configured to highlight the at least one state image so as to reflect the state of the external device into the state image.

12. The controller according to claim 2, wherein the state display section is configured to detect the state of the external device at a predetermined period.

13. The controller according to claim 3, wherein the state display section is configured to detect the state of the external device at a predetermined period.

14. The controller according to claim 11, wherein the state display section is configured to detect the state of the external device at a predetermined period.

15. The controller according to claim 2, wherein the state display section is configured to access a directly accessible storage device through a telecommunication line so as to detect the state of the external device.

16. The controller according to claim 3, wherein the state display section is configured to access a directly accessible storage device through a telecommunication line so as to detect the state of the external device.

17. The controller according to claim 4, wherein the state display section is configured to access a directly accessible storage device through a telecommunication line so as to detect the state of the external device.

18. The controller according to claim 11, wherein the state display section is configured to access a directly accessible storage device through a telecommunication line so as to detect the state of the external device.

19. The controller according to claim 12, wherein the state display section is configured to access a directly accessible storage device through a telecommunication line so as to detect the state of the external device.

20. The controller according to claim 13, wherein the state display section is configured to access a directly accessible storage device through a telecommunication line so as to detect the state of the external device.
